(19) United States
(12) Patent Application Publication
(10) Pub. No.: US 2025/0351955 A1
(43) Pub. Date: Nov. 20, 2025

(54) Tray Workstation Apparatus

(71) Applicant: Carson J. Warstler, Ludowici, GA (US)

(72) Inventor: Carson J. Warstler, Ludowici, GA (US)

(21) Appl. No.: 19/212,344

(22) Filed: May 19, 2025

Related U.S. Application Data
(60) Provisional application No. 63/649,206, filed on May 17, 2024.

(51) Int. Cl. A47B 23/00; B62B 5/00

(52) U.S. Cl. CPC A47B 23/001; B62B 5/00

(57) ABSTRACT

The tray workstation apparatus is an attachment that increases the efficiency of workers in environments that utilize shopping carts. The tray workstation apparatus sits atop a shopping cart, providing a stable surface for workers to place and operate electronic devices, Furthermore, the tray workstation apparatus provides a surface to carry supplies needed to change price tags, shelf labels, and other supplies necessary to perform tasks. The tray workstation apparatus is adjustable via clamps. The tray workstation apparatus has a tray body with sidewalls, and a reversable front wall. Each wall is secured together with screws to form a square shaped walled platform that may receive accessories such as a cup holder, tray holder, label stacker, or label dispenser.

### FIELD OF THE INVENTION

The present invention relates generally to shopping carts. More specifically, an apparatus which attaches to the top of a shopping cart and serves to enhance the efficiency of workers in environments utilizing shopping carts.

### BACKGROUND OF THE INVENTION

This invention is targeted at users who work in environments with shopping carts. Today's workers often carry electronic devices such as laptops, tablets, and portable data terminals for tasks involving data entry and retrieval via wireless transmission. These devices are essential for scanning products, accessing backstock information, retrieving pricing details, and other relevant product data. Additionally, many workers utilize portable printers with multiple label types for creating various printed materials necessary for their job functions. Workers often carry trays of shelf tags and new shelf labels which must be replaced on a regular basis as prices change.

In the absence of the present invention, workers typically resort to placing these electronic devices, and printers, and shelf tags in the shopping cart basket, which can be inconvenient and inefficient. This arrangement forces workers to operate without a stable surface, leading to difficulties in performing tasks effectively. The present invention addresses these challenges by providing a stable and organized workspace for workers.

### BRIEF DESCRIPTION OF THE DRAWINGS

FIG. 1 is a top front right exploded perspective view of the present invention.

FIG. 2 is a bottom rear left exploded perspective view of the present invention.

FIG. 3 is a top front left configured perspective view of the present invention.

FIG. 4 is a bottom rear right configured perspective view of the present invention.

FIG. 5 is a front view of the present invention.

FIG. 6 is a rear view of the present invention.

FIG. 7 is a right-side view of the present invention.

FIG. 8 is a left-side view of the present invention.

FIG. 9 is a top plan view of the present invention.

FIG. 10 is a bottom plan view of the present invention.

FIG. 11 is a top front right perspective view of the walled platform wherein the front wall body is oriented upside-down.

### DETAILED DESCRIPTION OF THE INVENTION

All illustrations of the drawings are for the purpose of describing selected versions of the present invention and are not intended to limit the scope of the present invention.

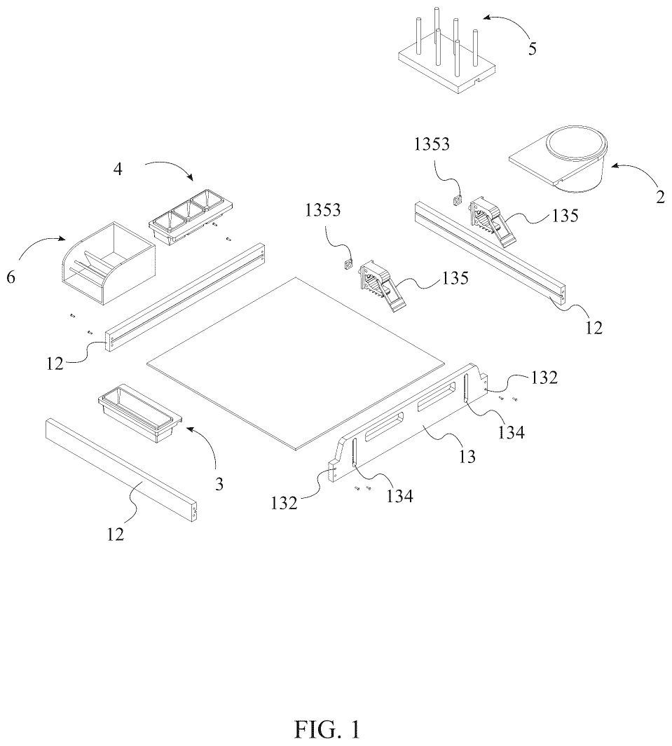

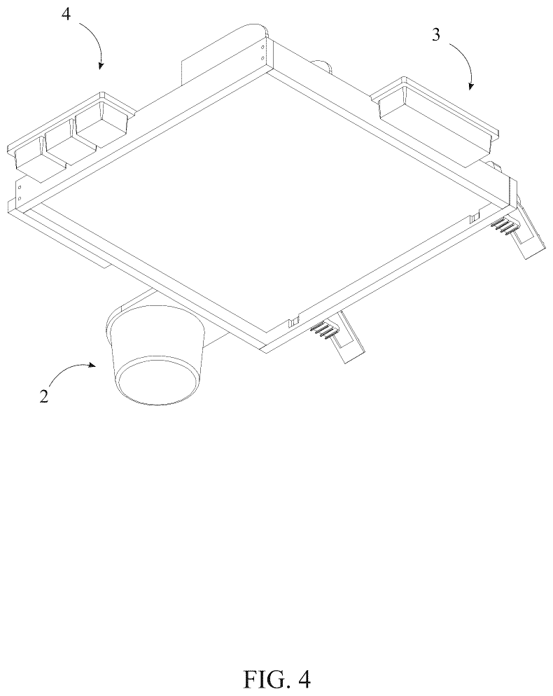

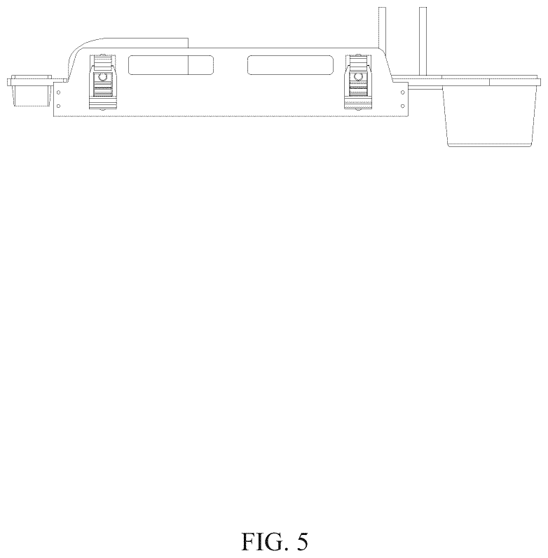

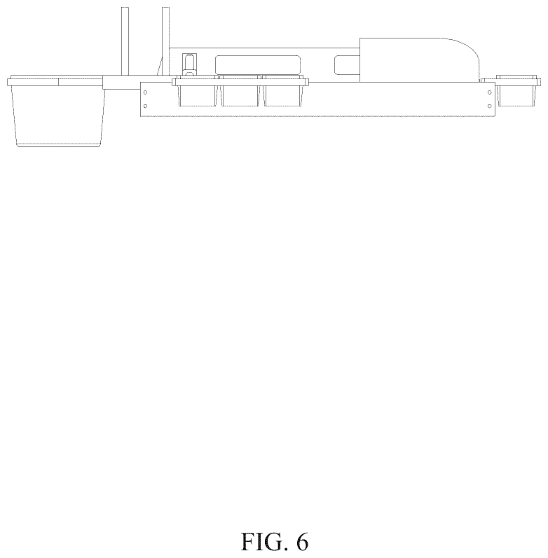

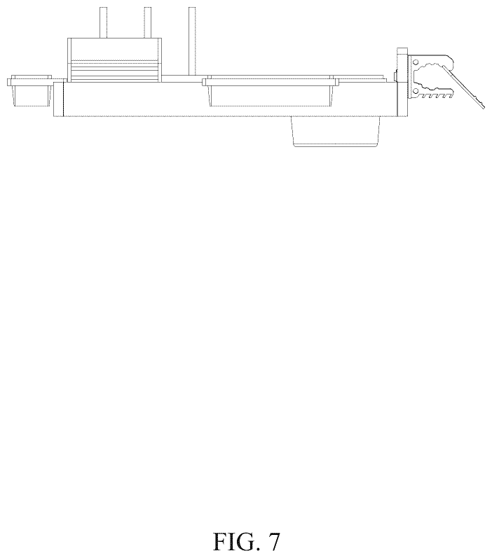

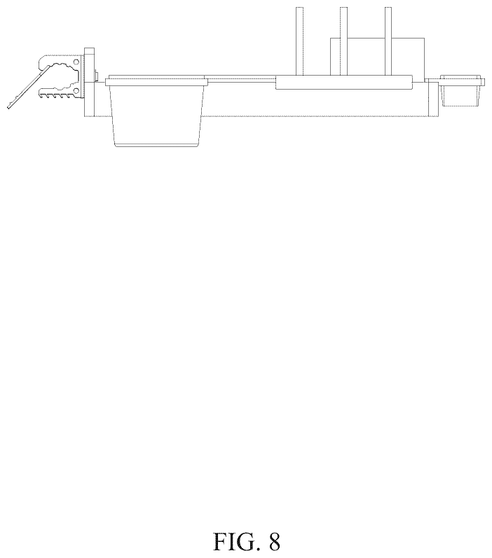

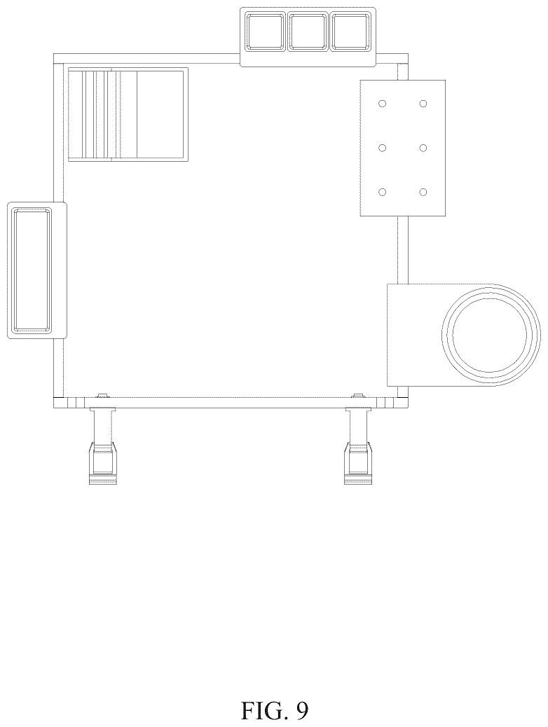

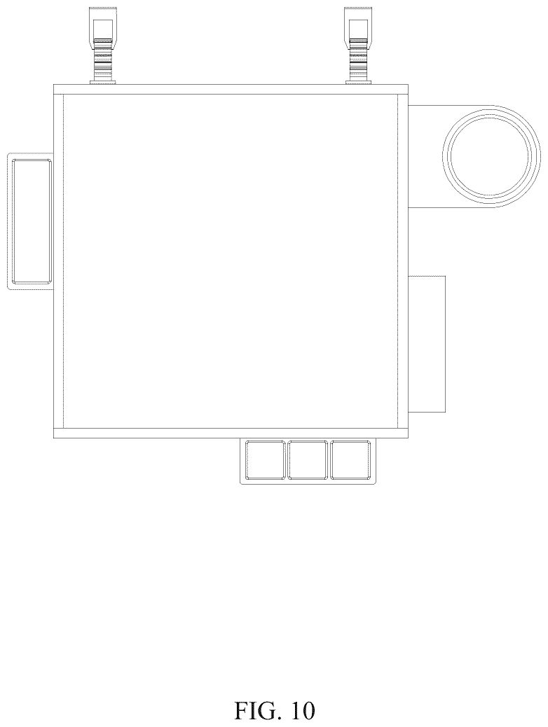

As can be seen in FIG. 1 through 11, the present invention, is an innovative attachment designed to enhance the efficiency of workers in environments utilizing shopping carts. This workstation provides a stable surface for workers to place and operate electronic devices such as laptops, tablets, and portable data terminals (PDT), as well as accommodate portable printers for creating labels, shelf tags, and price tags. By organizing these tools within easy reach, the present invention streamlines workflows, improves efficiency, and reduces the hassle associated with fumbling for items in a shopping cart.

The present invention sits on top of a shopping cart when the child seat or basket is extended. The uniquely designed paddle shaped front frame of the present invention allows vertical adjustability to level the present invention. Multiple levels of adjustability are achieved with the plurality of clamps 135. The present invention comprises a tray body 1, wherein the tray body 1 comprises a plurality of sidewalls 12, and a front wall body 13. The tray body 1 is a square shaped panel. Each of the plurality of sidewalls 12 is a rectangular shaped panel that secures along the sides of the tray body 1. The front wall body 13 is a panel with a larger width than each of the plurality of sidewalls 12. The front wall body 13 is usually positioned adjacent to the front of a shopping cart wherein the rear side of the tray body 1 rests along the edges of the shopping cart. The plurality of sidewalls 12 further comprises a plurality of holes 121 and a plurality of sidewall slots 122. Each of the plurality of holes 121 is a circular shaped hole configured to receive a screw, further each of the plurality of holes 121 may have a threaded inner surface. The plurality of holes 121 is positioned along the ends of each of the plurality of sidewalls 12. The plurality of sidewall slots 122 is a groove positioned along the bottom side of the inner surface of each of the plurality of sidewalls 12. The plurality of sidewall slots 122 is configured to receive the tray body 1, forming one body. The front wall body 13 further comprises a plurality of screws 131, a plurality of screw holes 132, a plurality of handle holes 133, a plurality of clamp slots 134, a plurality of clamps 135, and a front wall slot 136. The plurality of screws 131 is designed to engage with the plurality of holes 121, securing the front wall body 13 to the plurality of sidewalls 12 and the tray body 1. The plurality of screws 131 traverses through each of the plurality of screw holes 132, which are a circular shape and positioned along the ends of the front wall body 13. Each of the plurality of handle holes 133 is a rectangular shaped hole that traverses through the central portion of the front wall body 13, forming handle structures along the top end of the front wall body 13. Each of the plurality of clamp slots 134 is an elongated slot shaped hole that traverses through the front wall body 13, enabling each of the plurality of clamps 135 to engage to each of the plurality of clamp slots 134, wherein each of the plurality of clamps 135 may be vertically adjusted within each of the plurality of clamp slots 134. The plurality of clamps 135 is configured to engage with shopping cart handles of all sizes. The front wall slot 136 is a groove positioned along the inner surface of the front wall body 13, configured to engage with the tray body 1. The plurality of sidewalls 12 is positioned along three sides of the tray body 1. The front wall body 13 is positioned along a side of the tray body 1 adjacent to the plurality of sidewalls 12, wherein the front wall body 13 and the plurality of sidewalls 12 form a square or rectangular shape when positioned correctly.

The tray body 1, front wall body 13, and plurality of sidewalls 12 forms a walled platform 7. The walled platform 7 is a square or rectangular shaped box with a base, being the tray body 1. The walled platform 7 has several walls, being the plurality of sidewalls 12 and the front wall body 13. The plurality of clamps 135 is configured to secure the walled platform 7 to an elongated structure. The plurality of clamps 135 is configured to attach and engage with a shopping cart handle of various shaped and sizes. The plurality of screws 131 fastens the front wall body 13 to the plurality of sidewalls 12, and around the tray body 1. Thus, the walled platform 7 is formed. The plurality of sidewall slots 122 and the front wall slot 136 engages with the tray body 1. This configuration secures the tray body 1 in place with respect to the plurality of sidewalls 12 and front wall body 13.

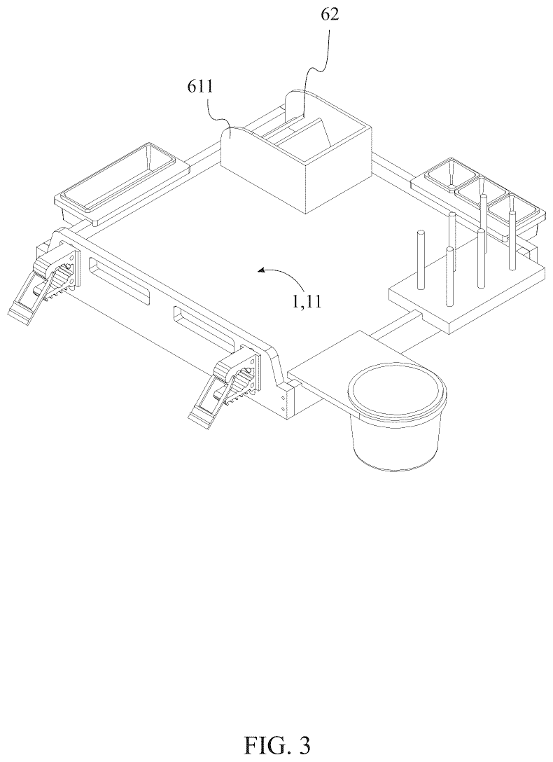

As shown in FIG. 3, the tray body 1 further comprises a top surface 11. The tray body 1 is a lightweight material. The tray body 1 is a material selected from the group comprising an aluminum composite material and polyvinylidene fluoride or similar material. As a result, the tray body 1 is lightweight while structurally supportive of any objects placed atop the top surface 11. The top surface 11 is a material with gripping properties. Consequently, the top surface 11 may be a vinyl or rubber mat which covers the top of the tray body 1 and is configured to keep things in their intended position and not move as the shopping cart turns corners or is pushed around. The vinyl mat may come in different colors. Furthermore, the top surface 11 enables users to have their logos printed on the mat allowing the present invention to be customized for individual users or companies.

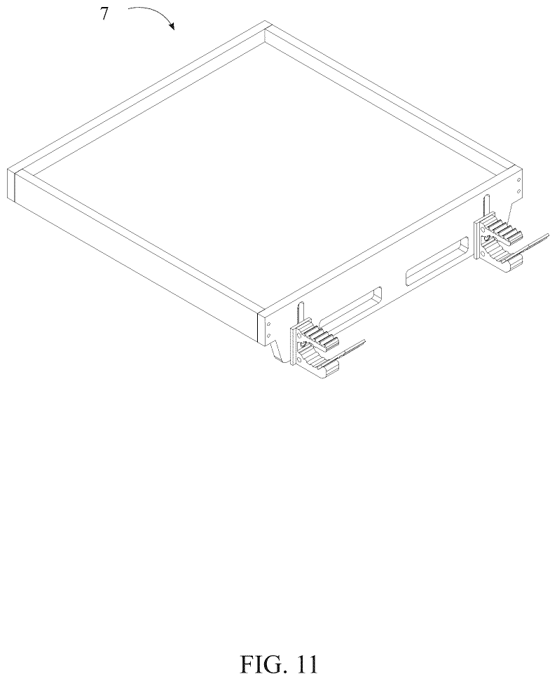

Further, the present invention is configured to accommodate various shaped and sized shopping carts through the adjustability of the front wall body 13. The front wall body 13 may be oriented upside down, wherein the plurality of handle holes 133 is positioned below the top surface 11 as seen in FIG. 11. The walled platform 7 may have a rectangular shape. In an alternative embodiment the walled platform 7 may have a rectangular shape or a smaller square shape, for example, the walled platform 7 may be 22 inches by 28 inches and stick out over the shopping cart, or the walled platform 7 may be 16 inches by 16 inches to fit a smaller sized shopping cart.

As shown in FIG. 1, each of the plurality of clamps 135 further comprising a rubber fastener 1351, a clamp screw 1352, and a clamp nut 1353. The rubber fastener 1351 is configured to wrap around a shopping cart handle and couple each of the plurality of clamps 135 to the shopping cart handle. The rubber fastener 1351 is designed with a flexible material that enables various sized shopping cart handles to be accommodated. The clamp screw 1352 traverses through the clamp and clamp slot wherein the clamp screw 1352 is fastened to the clamp nut 1353. As a result, each of the plurality of clamps 135 is positioned along each of the plurality of clamp slots 134, wherein the clamp nut 1353 is secured in place while the clamp screw 1352 tightens each of the plurality of clamps 135 into place. The clamp screw 1352 may be vertically adjusted within the clamp slot. Consequently, each of the plurality of clamps 135 may be vertically adjusted along the front wall body 13 to accommodate various shaped shopping carts with shopping cart handles of varying heights.

Further, the present invention comprises a cup holder body 2. The cup holder body 2 is a rectangular panel wherein one side has a semi-circular shape as seen in FIG. 1. The cup holder body 2 further comprising a cup holder slot 21 and a cup holder receiver 22. The cup holder slot 21 is a groove positioned along the bottom of the cup holder body 2, enabling the cup holder body 2 to engage along the walled platform 7, on either the front wall body 13 or the plurality of sidewalls 12. The cup holder body 2 engages along the walled platform 7 and may be positioned in various locations. Furthermore, the cup holder slot 21 is positioned along the bottom of the cup holder body 2. The cup holder slot 21 traverses partially through the cup holder body 2, enabling the cup holder slot 21 to slide along the front wall body 13 or the plurality of sidewalls 12. The cup holder receiver 22 is integrated into the cup holder body 2 and is configured to receive a cup or cylindrical object. Accordingly, the cup holder receive is a hollow component that extends downwards from the cup holder body 2.

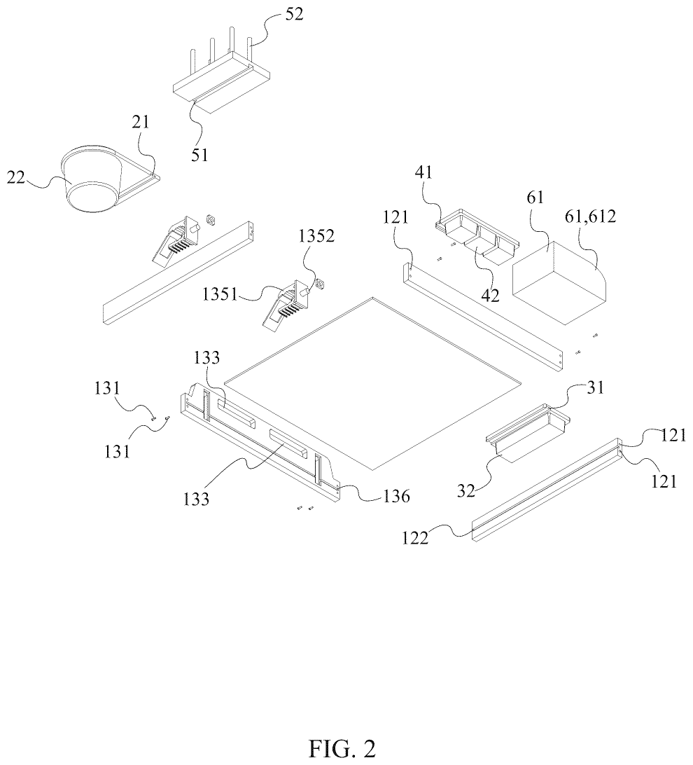

Further, the present invention comprises a single tray body 3 as shown in FIG. 2. The single tray body 3 is a rectangular member that may be positioned adjacent to the walled platform 7. The single tray body 3 further comprising a single tray holder slot 31 and an elongated tray 32. The tray holder slot is a groove positioned along the bottom of the single tray body 3 that is configured to receive the front wall body 13 or the plurality of sidewalls 12. The single tray body 3 engages along the walled platform 7. The single tray body 3 has a rectangular shape. Furthermore, the single tray holder slot 31 is positioned along the bottom of the single tray body 3, wherein the single tray holder slot 31 traverses partially through the single tray body 3. The elongated tray 32 is integrated into the single tray body 3. The elongated tray 32 extends downwards and is configured to receive elongated objects such as pens and pencils.

Further, the present invention comprises a triple tray body 4. The triple tray body 4 further comprising a triple tray holder slot 41 and a plurality of trays 42. Each of the plurality of trays 42 is a plastic or lightweight square shaped tray configured to hold small objects, wherein each of the plurality of trays 42 is evenly spaced away from each other. The triple tray body 4 engages along the walled platform 7. Furthermore, the triple tray holder slot 41 is positioned along the bottom of the triple tray body 4. The trip tray body 4 is a rectangular shaped member with a plurality of openings to receive the plurality of trays 42. The triple tray holder slot 41 traverses partially through the triple tray body 4. The plurality of trays 42 is integrated into the triple tray body 4.

Further, the present invention comprises a label stacker body 5 as shown in FIG. 1. The label stacker body 5 further comprising a label stacker slot 51 and a plurality of label stacker rods 52. Each of the plurality of label stacker rods 52 is a cylindrical shaped member that extends upwards from the label stacker body 5. Each of the label stacker rods is evenly distributed along the top of the label stacker body 5. The plurality of label stacker rods 52 is preferably designed with a nylon material but may utilize a stainless steel or other similar material. The label stacker body 5 engages along the walled platform 7 and may be positioned in various ways. Furthermore, wherein the label stacker slot 51 is positioned centrally along the bottom of the label stacker body 5. The label stacker slot 51 traverses partially through the label stacker body 5. The plurality of label stacker rods 52 is integrated into the label stacker body 5 and extends upwards. Each of the plurality of label stacker rods 52 is removable from the label stacker body 5. Thus, each of the plurality of label stacker rods 52 may be repositioned to receive and accommodate label rolls of various shapes and sizes.

Further, the present invention comprises a label dispenser body 6 as seen in FIG. 1. The label dispenser body 6 further comprising a plurality of label dispenser sidewalls 61 and a plurality of label dispenser rods 62. The plurality of label dispenser sidewalls 61 comprises a left label dispenser sidewall 611 and a right label dispenser sidewall 612. The label dispenser body 6 rests upon the center of the walled platform 7 and does not engage with the walls of the walled platform 7. Furthermore, the plurality of label dispenser sidewalls 61 is positioned along three sides of the label dispenser body 6 to form a box structure. As a result, the plurality of label dispenser sidewalls 61 forms a hollow box shape with two open sides. The plurality of label dispenser rods 62 traverses from the left label dispenser sidewall 611 to the right label dispenser sidewall 612. So, the plurality of label dispenser rods 62 is positioned at varying heights along the plurality of dispenser sidewalls wherein a label roll may easily traverse in between each of the plurality of dispenser rods, enabling the user to easily pull the labels across the plurality of dispenser rods, while the label roll unwinds and stays secured within the label dispenser body 6. The plurality of label dispenser rods 62 is designed with a nylon material and may rotate in place while secured to the plurality of dispenser sidewalls.

Furthermore, each slot may be cut to shape with a CNC router or similar machining process. Each of the plurality of sidewalls 12 and the front wall body 13 may be cut to shape with a CNC router or similar machining process and further assembled and attached to form the walled platform 7.

Although the invention has been explained in relation to its preferred embodiment, it is to be understood that many other possible modifications and variations can be made without departing from the spirit and scope of the invention as hereinafter claimed.

What is claimed is:

1. A tray workstation apparatus comprising:
a tray body;
wherein the tray body comprises a plurality of sidewalls, and a front wall body;
wherein the plurality of sidewalls further comprises a plurality of holes and a plurality of sidewall slots;
wherein the front wall body further comprises a plurality of screws, a plurality of screw holes, a plurality of handle holes, a plurality of clamp slots, a plurality of clamps, and a front wall slot;
the plurality of sidewalls is positioned along three sides of the tray body;
the front wall body is positioned along a side of the tray body adjacent to the plurality of sidewalls;
wherein the tray body, front wall body, and plurality of sidewalls forms a walled platform;
the plurality of clamps is configured to secure the walled platform to an elongated structure;
the plurality of screws fastens the front wall body to the plurality of sidewalls, and around the tray body; and
the plurality of sidewall slots and the front wall slot engages with the tray body.

2. The tray workstation apparatus as claimed in claim 1 comprising:
wherein the tray body further comprises a top surface;
wherein the tray body is a lightweight material;
wherein the tray body is a material selected from the group comprising an aluminum composite material and polyvinylidene fluoride or a similar material; and
the top surface is a material with gripping properties.

3. The tray workstation apparatus as claimed in claim 2 comprising:
wherein the front wall body is oriented upside down, wherein the plurality of handle holes is positioned below the top surface; and
wherein the walled platform may have rectangular shape.

4. The tray workstation apparatus as claimed in claim 1 comprising:
each of the plurality of clamps further comprising a rubber fastener, a clamp screw, and a clamp nut;
wherein the clamp screw traverses through the clamp and clamp slot wherein the clamp screw is fastened to the clamp nut; and
wherein the clamp screw may be vertically adjusted within the clamp slot.

5. The tray workstation apparatus as claimed in claim 1 comprising:
a cup holder body;
the cup holder body further comprising a cup holder slot and a cup holder receiver; and
wherein the cup holder body engages along the walled platform.

6. The tray workstation apparatus as claimed in claim 5 comprising:
wherein the cup holder slot is positioned along the bottom of the cup holder body;
wherein the cup holder slot traverses partially through the cup holder body; and
wherein the cup holder receiver is integrated into the cup holder body and is configured to receive a cup or cylindrical object.

7. The tray workstation apparatus as claimed in claim 1 comprising:
a single tray body;
the single tray body further comprising a single tray holder slot and an elongated tray;
wherein the single tray body engages along the walled platform; and
wherein the single tray body has a rectangular shape.

8. The tray workstation apparatus as claimed in claim 7 comprising:
wherein the single tray holder slot is positioned along the bottom of the single tray body;
wherein the single tray holder slot traverses partially through the single tray body; and
wherein the elongated tray is integrated into the single tray body.

9. The tray workstation apparatus as claimed in claim 1 comprising:
a triple tray body;
the triple tray body further comprising a triple tray holder slot and a plurality of trays; and
wherein the triple tray body engages along the walled platform.

10. The tray workstation apparatus as claimed in claim 9 comprising:
wherein the triple tray holder slot is positioned along the bottom of the triple tray body;
wherein the triple tray holder slot traverses partially through the triple tray body; and
wherein the plurality of trays is integrated into the triple tray body.

11. The tray workstation apparatus as claimed in claim 1 comprising:
a label stacker body;
the label stacker body further comprising a label stacker slot and a plurality of label stacker rods; and
wherein the label stacker body engages along the walled platform.

12. The tray workstation apparatus as claimed in claim 11 comprising:
wherein the label stacker slot is positioned along the bottom of the label stacker body;
wherein the label stacker slot traverses partially through the label stacker body;
wherein the plurality of label stacker rods is integrated into the label stacker body and extends upwards; and
wherein each of the plurality of label stacker rods is removable from the label stacker body.

13. The tray workstation apparatus as claimed in claim 1 comprising:
a label dispenser body;
the label dispenser body further comprising a plurality of label dispenser sidewalls and a plurality of label dispenser rods;
wherein the plurality of label dispenser sidewalls comprises a left label dispenser sidewall and a right label dispenser sidewall; and
wherein the label dispenser body rests upon the walled platform.

14. The tray workstation apparatus as claimed in claim 13 comprising:
wherein the plurality of label dispenser sidewalls is positioned along three sides of the label dispenser body to form a box structure; and
wherein the plurality of label dispenser rods traverses from the left label dispenser sidewall to the right label dispenser sidewall.

15. A tray workstation apparatus comprising:
a tray body;
wherein the tray body comprises a plurality of sidewalls, and a front wall body;
wherein the plurality of sidewalls further comprises a plurality of holes and a plurality of sidewall slots;
wherein the front wall body further comprises a plurality of screws, a plurality of screw holes, a plurality of handle holes, a plurality of clamp slots, a plurality of clamps, and a front wall slot;
the plurality of sidewalls is positioned along three sides of the tray body;
the front wall body is positioned along a side of the tray body adjacent to the plurality of sidewalls;
wherein the tray body, front wall body, and plurality of sidewalls forms a walled platform;
the plurality of clamps is configured to secure the walled platform to an elongated structure;
the plurality of screws fastens the front wall body to the plurality of sidewalls, and around the tray body;
the plurality of sidewall slots and the front wall slot engages with the tray body;
wherein the tray body further comprises a top surface;
wherein the tray body is a lightweight material;
wherein the tray body is a material selected from the group comprising an aluminum composite material and polyvinylidene fluoride or a similar material;
the top surface is a material with gripping properties;
each of the plurality of clamps further comprising a rubber fastener, a clamp screw, and a clamp nut; and
a cup holder body.

16. The tray workstation apparatus as claimed in claim 15 comprising:
wherein the front wall body is oriented upside down, wherein the plurality of handle holes is positioned below the top surface; and
wherein the walled platform may have rectangular shape.

17. The tray workstation apparatus as claimed in claim 15 comprising:
wherein the clamp screw traverses through the clamp and clamp slot wherein the clamp screw is fastened to the clamp nut; and
wherein the clamp screw may be vertically adjusted within the clamp slot.

18. The tray workstation apparatus as claimed in claim 15 comprising:
the cup holder body further comprising a cup holder slot and a cup holder receiver;
wherein the cup holder body engages along the walled platform;
wherein the cup holder slot is positioned along the bottom of the cup holder body;
wherein the cup holder slot traverses partially through the cup holder body; and
wherein the cup holder receiver is integrated into the cup holder body and is configured to receive a cup or cylindrical object.

19. The tray workstation apparatus as claimed in claim 15 comprising:
a single tray body;
the single tray body further comprising a single tray holder slot and an elongated tray;
wherein the single tray body engages along the walled platform;
wherein the single tray body has a rectangular shape;
wherein the single tray holder slot is positioned along the bottom of the single tray body;
wherein the single tray holder slot traverses partially through the single tray body;
wherein the elongated tray is integrated into the single tray body;
a triple tray body;
the triple tray body further comprising a triple tray holder slot and a plurality of trays;
wherein the triple tray body engages along the walled platform;
wherein the triple tray holder slot is positioned along the bottom of the triple tray body;
wherein the triple tray holder slot traverses partially through the triple tray body; and
wherein the plurality of trays is integrated into the triple tray body.

20. The tray workstation apparatus as claimed in claim 15 comprising:
a label stacker body;
the label stacker body further comprising a label stacker slot and a plurality of label stacker rods;
wherein the label stacker body engages along the walled platform;
wherein the label stacker slot is positioned along the bottom of the label stacker body;
wherein the label stacker slot traverses partially through the label stacker body;
wherein the plurality of label stacker rods is integrated into the label stacker body and extends upwards;
wherein each of the plurality of label stacker rods is removable from the label stacker body;
a label dispenser body;
the label dispenser body further comprising a plurality of label dispenser sidewalls and a plurality of label dispenser rods;
wherein the plurality of label dispenser sidewalls comprises a left label dispenser sidewall and a right label dispenser sidewall;
wherein the label dispenser body rests upon the walled platform;
wherein the plurality of label dispenser sidewalls is positioned along three sides of the label dispenser body to form a box structure; and
wherein the plurality of label dispenser rods traverses from the left label dispenser sidewall to the right label dispenser sidewall.
